(19) United States
(12) Patent Application Publication
(10) Pub. No.: US 2025/0095478 A1
(43) Pub. Date: Mar. 20, 2025

(54) APPARATUS AND METHOD FOR PROVIDING CROSSWALK PEDESTRIAN GUIDANCE BASED ON IMAGE AND BEACON

(71) Applicant: ELECTRONICS AND TELECOMMUNICATIONS RESEARCH INSTITUTE, Daejeon (KR)

(72) Inventors: Byung-Ok HAN, Daejeon (KR); Do-Hyung KIM, Daejeon (KR); Jae-Hong KIM, Daejeon (KR); Woo-Han YUN, Daejeon (KR)

(21) Appl. No.: 18/676,563

(22) Filed: May 29, 2024

(30) Foreign Application Priority Data
Sep. 19, 2023 (KR) 10-2023-0124659

(51) Int. Cl. G08G 1/005; G01S 1/04; G01S 13/46; G06V 10/82; G06V 20/52; G08G 1/16

(52) U.S. Cl. CPC G08G 1/005; G01S 1/0428; G01S 13/46; G06V 10/82; G06V 20/52; G08G 1/166; G01S 2013/466

(57) ABSTRACT

Disclosed herein are an apparatus and method for providing crosswalk pedestrian guidance based on an image and a beacon. The method for providing crosswalk pedestrian guidance based on an image and a beacon may include estimating a walking location based on a beacon signal corresponding to at least one traffic light and first-person view sensor information, analyzing a hazard factor around a pedestrian based on an image acquired from a camera corresponding to the traffic light, predicting a hazard around the pedestrian in combination by considering together the walking location, the hazard factor, and status information of the traffic light, and providing walking guidance to a pedestrian guidance terminal based on the predicted hazard around the pedestrian.

### CROSS REFERENCE TO RELATED APPLICATION

This application claims the benefit of Korean Patent Application No. 10-2023-0124659, filed Sep. 19, 2023, which is hereby incorporated by reference in its entirety into this application.

### BACKGROUND OF THE INVENTION

### 1. Technical Field

The following embodiments relate to technology for providing walking guidance at traffic lights for vulnerable pedestrians including the visually impaired, the elderly, and children.

### 2. Description of Related Art

In order to routinely ensure safe crossing on roads with traffic lights, people cross the roads while checking each traffic light (color) as to whether it indicates that it is safe to walk, observing the movement of vehicles or other hazards, and verifying their positions on the crosswalk in combination. However, this may be a challenging task for vulnerable pedestrians such as the visually impaired or the elderly or children who walk slowly. For vulnerable pedestrians, safe road crossing is an essential element of the right to walk/travel.

Meanwhile, it is difficult for a walking guidance system to utilize Global Positioning System (GPS) information, unlike typical GPS-based vehicle navigation system. It is known that an error range of a GPS is about 20 m, which is larger than a walking guidance scale, thus resulting in a hazardous situation.

Additionally, there may frequently occur situations where walking guidance is not technically possible using GPS information, such as guiding pedestrians on sidewalks in urban areas with dense buildings, providing walking guidance inside buildings, and providing detour information due to construction.

Particularly, because a walking guidance system for vulnerable pedestrians needs to ensure safe walking, sensor information from a first-person view, such as information obtained from RGB cameras, LiDAR, ultrasonic, and depth cameras, rather than relying on GPS, is primarily used. By utilizing such sensor information, it is possible to provide guidance on the locations of roads allowed to walk, obstacle avoidance, notification of hazardous situations, etc.

Here, the first-person view sensor information may refer to sensing information for walking guidance provided from a sensor for walking guidance, which is located on a pedestrian or located closer to the pedestrian.

Recently, with the development of Artificial Intelligence (AI) technology, first-person view walking guidance systems for vulnerable pedestrians using first-person view sensor information, such as information obtained from walking guidance robot/drone, a pedestrian-wearable device (e.g., AI backpack, smart glasses, etc.), and a smartphone, have been continuously developed. In particular, during walking guidance, crossing the road is the most challenging and life-threatening task, and thus accurate and reliable guidance is the most important thing. For road crossing, the existence/non-existence and the location of crosswalks, the status of a traffic light indicating whether a pedestrian is allowed to walk, and the movement of hazards (dangers) such as vehicles from left/right sides need to be continuously and comprehensively monitored.

However, a first-person view walking guidance system has the following limitations making it difficult to provide accurate walking guidance.

First, the essential problem of a first-person view sensor is to cause a hiding phenomenon (occlusion) attributable to an obstacle or to face in a direction other than that of the target to be recognized. That is, when the sensor is hidden by another object or faces in another direction, it is difficult to accurately check the color of the traffic light, the location of crosswalks, and the existence of a hazardous moving object, thus making it impossible to provide walking guidance.

Next, although the sensor is not hidden, detection performance for the color of the traffic light, the location of crosswalks, and the existence of a moving object needs to be close to 100% accurate regardless of environmental variables such as illuminance, backlight, and weather. Detection errors occurring during road crossing may put a person's life at risk.

### SUMMARY OF THE INVENTION

An embodiment is intended to provide walking guidance that helps a vulnerable pedestrian safely cross the road at a crosswalk with a traffic light.

An embodiment is intended to solve occlusion occurring when a first-person view sensor used in walking guidance is hidden by an obstacle, or a problem occurring when the first-person view sensor faces in a direction other than that of the target to be recognized.

An embodiment is intended to accurately detect the color of a traffic light, the location of a crosswalk, and the existence of a moving object so as to provide walking guidance, regardless of environmental variables such as illuminance, backlight, and weather.

In accordance with an aspect of the present disclosure, there is provided a method for providing crosswalk pedestrian guidance based on an image and a beacon, including estimating a walking location based on a beacon signal corresponding to at least one traffic light and first-person view sensor information, analyzing a hazard factor around a pedestrian based on an image acquired from a camera corresponding to the traffic light, predicting a hazard around the pedestrian in combination by considering together the walking location, the hazard factor, and status information of the traffic light, and providing walking guidance to a pedestrian guidance terminal based on the predicted hazard around the pedestrian.

Estimating the walking location may include receiving a first walking location estimated based on the first-person view sensor information from the pedestrian guidance terminal, estimating a second walking location based on the beacon signal, and estimating a third walking location by combining the first walking location with the second walking location.

Estimating the second walking location may include estimating the second walking location through trilateration based on beacon signals received by the pedestrian guidance terminal from four or more traffic lights.

Estimating the third walking location may include estimating a point having a highest value to be the third walking location based on at least one of probabilities or reliabilities of respective results of estimating the first walking location and the second walking location, or a combination thereof.

Analyzing the hazard factor around the pedestrian may include searching for at least one camera around an identified traffic light, receiving a real-time image around a crosswalk from the found at least one camera, and recognizing a hazard factor including a speed of at least one vehicle approaching the crosswalk, a lane, an obstacle, and a degree of walking congestion.

The traffic light status information may include a color and a lighting time of the traffic light.

Predicting the hazard in the combined manner may be performed based on a deep neural network that is pre-trained to infer a walking direction and a hazard degree by receiving the walking location, the hazard factor, and the traffic light status information as input.

Predicting the hazard in the combined manner may be performed based on heuristic hazard prediction of calculating a hazard degree in a corresponding hazardous situation based on hazard degrees manually set for hazardous situations designated for respective cases.

In accordance with another aspect of the present disclosure, there is provided an apparatus for providing crosswalk pedestrian guidance based on an image and a beacon, including memory configured to store at least one program, and a processor configured to execute the program, wherein the program is configured to estimate a walking location based on a beacon signal corresponding to at least one traffic light and first-person view sensor information, analyze a hazard factor around a pedestrian based on an image acquired from a camera corresponding to the traffic light, predict a hazard around the pedestrian in combination by considering together the walking location, the hazard factor, and status information of the traffic light, and provide walking guidance to a pedestrian guidance terminal based on the predicted hazard around the pedestrian.

The program may be configured to, in estimating the walking location, receive a first walking location estimated based on the first-person view sensor information from the pedestrian guidance terminal, estimate a second walking location based on the beacon signal, and estimate a third walking location by combining the first walking location with the second walking location.

The program may be configured to, in estimating the second walking location, estimate the second walking location through trilateration based on beacon signals received by the pedestrian guidance terminal from four or more traffic lights including an identified traffic light.

The program may be configured to, in estimating the third walking location, estimate a point having a highest value to be the third walking location based on at least one of probabilities or reliabilities of respective results of estimating the first walking location and the second walking location, or a combination thereof.

The program may be configured to, in analyzing the hazard factor around the pedestrian, search for at least one camera around an identified traffic light, receive a real-time image around a crosswalk from the found at least one camera, and recognize a hazard factor including a speed of at least one vehicle approaching the crosswalk, a lane, an obstacle, and a degree of walking congestion.

The traffic light status information may include a color and a lighting time of the traffic light.

The program may be configured to, in predicting the hazard in the combined manner, perform hazard prediction based on a deep neural network that is pre-trained to infer a walking direction and a hazard degree by receiving the walking location, the hazard factor, and the traffic light status information as input.

In accordance with a further aspect of the present disclosure, there is provided a pedestrian guidance terminal, including memory configured to store at least one program, and a processor configured to execute the program, wherein the program is configured to output final walking guidance information and hazard warning by determining safety in combination based on walking guidance information and a result of predicting a hazard around a pedestrian, which are estimated based on first-person view sensor information, and walking guidance information and a result of predicting a hazard around the pedestrian, which are received from a safe walking server.

The program may be configured to transfer a beacon signal received from a smart device installed on a traffic light to the safe walking server after the pedestrian starts walking along a path.

The program may be configured to transfer a first waling location estimated based on the first-person view sensor information to the safe walking server.

The program may be configured to output in advance primary walking information based on the walking guidance information and the result of predicting the hazard around the pedestrian, which are estimated based on the first-person view sensor information, before receiving the walking guidance information and the result of predicting the hazard around the pedestrian from the safe walking server.

The program may be configured to output final walking information based on a pre-trained deep neural network that infers a final walking guidance direction and a final hazard degree by receiving a primary walking guidance direction, a primary hazard degree, a secondary walking guidance direction, and a secondary hazard degree as input.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a diagram for explaining an example of a system for providing crosswalk pedestrian guidance based on an image and a beacon according to an embodiment;

FIG. 2 is a schematic block configuration diagram of a pedestrian guidance terminal according to an embodiment;

FIG. 3 is a diagram illustrating the input/output of a combined safety determination unit according to an embodiment;

FIG. 4 is a diagram illustrating an example of a deep neural network for combined safety determination according to an embodiment;

FIG. 5 is a schematic block configuration diagram of a safe walking server according to an embodiment;

FIG. 6 is a diagram illustrating the input/output of a combined walking location estimation unit according to an embodiment;

FIG. 7 is a diagram illustrating the input/output of a combined hazard estimation unit according to an embodiment;

FIG. 8 is a diagram illustrating an example of a deep neural network for combined hazard prediction according to an embodiment;

FIG. 9 is a signal flowchart for explaining a method for providing crosswalk pedestrian guidance based on an image and a beacon according to an embodiment;

FIG. 10 is a flowchart for explaining the detailed step of generating secondary walking information according to an embodiment; and

FIG. 11 is a diagram illustrating the configuration of a computer system according to an embodiment.

### DESCRIPTION OF THE PREFERRED EMBODIMENTS

Advantages and features of the present disclosure and methods for achieving the same will be clarified with reference to embodiments described later in detail together with the accompanying drawings. However, the present disclosure is capable of being implemented in various forms, and is not limited to the embodiments described later, and these embodiments are provided so that this disclosure will be thorough and complete and will fully convey the scope of the present disclosure to those skilled in the art. The present disclosure should be defined by the scope of the accompanying claims. The same reference numerals are used to designate the same components throughout the specification.

It will be understood that, although the terms “first” and “second” may be used herein to describe various components, these components are not limited by these terms. These terms are only used to distinguish one component from another component. Therefore, it will be apparent that a first component, which will be described below, may alternatively be a second component without departing from the technical spirit of the present disclosure.

The terms used in the present specification are merely used to describe embodiments, and are not intended to limit the present disclosure. In the present specification, a singular expression includes the plural sense unless a description to the contrary is specifically made in context. It should be understood that the term “comprises” or “comprising” used in the specification implies that a described component or step is not intended to exclude the possibility that one or more other components or steps will be present or added.

Unless differently defined, all terms used in the present specification can be construed as having the same meanings as terms generally understood by those skilled in the art to which the present disclosure pertains. Further, terms defined in generally used dictionaries are not to be interpreted as having ideal or excessively formal meanings unless they are definitely defined in the present specification.

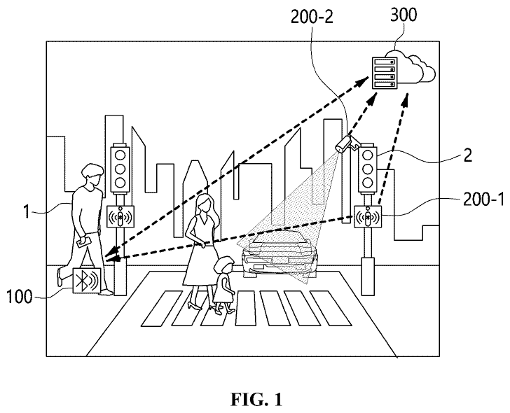

FIG. 1 is a diagram for explaining an example of a system for providing crosswalk pedestrian guidance based on an image and a beacon according to an embodiment.

Referring to FIG. 1, the system for providing crosswalk pedestrian guidance based on an image and a beacon according to the embodiment may perform reliable walking guidance and hazard warning essential for vulnerable pedestrians through a configuration in which a pedestrian guidance terminal 100, smart devices 200-1 and 200-2, and a safe walking server 300 are operated in conjunction with each other.

The pedestrian guidance terminal 100 may output a walking guidance direction and hazard warning at a crosswalk so that the walking guidance direction and hazard warning can be recognized by a pedestrian through at least one of visible, auditory, or tactile sensation, or a combination thereof.

For example, the pedestrian guidance terminal 100 may include a walking guidance robot, a walking guidance drone, a pedestrian-wearable device, etc. Here, the pedestrian-wearable device may include an AI backpack, smart glasses, etc.

However, when a traffic light is hidden (occlusion) by a person in front of the corresponding pedestrian, when the pedestrian guidance terminal 100 faces in another direction, or when it is difficult to detect a traffic light, an obstacle, or a hazardous object important to the pedestrian due to environmental factors such as illuminance, backlight, and weather, detection from the first-person view of the pedestrian guidance terminal 100 may frequently incur inaccurate detection results. Furthermore, such occlusion makes it difficult to avoid a hazardous situation even when a hazardous object such as a vehicle is approaching.

Therefore, in an embodiment, the pedestrian guidance terminal 100 performs image and beacon-based walking guidance by operating in conjunction with the smart devices 200-1 and 200-2 and the safe walking server 300 in order to solve the problem of occlusion and secure high accuracy.

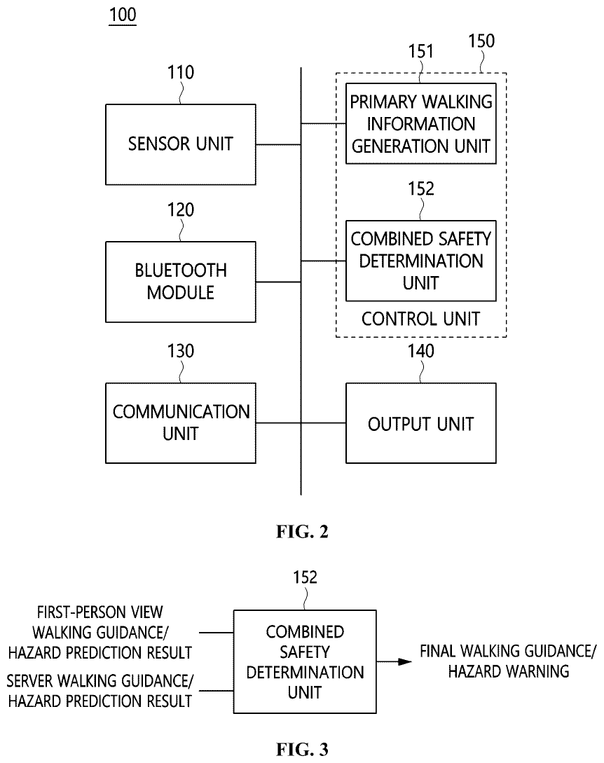

The detailed configuration of the pedestrian guidance terminal 100 will be described later with reference to FIGS. 2 and 3.

The smart devices 200-1 and 200-2 may include a smart traffic light 200-1 equipped with a beacon, and a camera 200-2 configured to capture images (video or footage) of roads and crosswalks around the traffic light in real time. Here, the camera 200-2 may be, for example, a Closed Circuit Television (CCTV) camera.

The smart traffic light 200-1 may be equipped with a minimum of four beacons, which may include three beacons for trilateration such as location estimation in GPS and one beacon for error correction.

Here, the term “beacon” refers to a wireless communication device which may automatically recognize a nearby smart device and transmit a signal to the recognized smart device. This performs wireless communication based on a Bluetooth 4.0 protocol to find the location of a user within a radius of 50 to 70 m, thus enabling message sending or mobile payment to be performed.

Here, the beacon periodically transmits a signal including its own ID and a Received Signal Strength Indicator (RSSI). Also, when the smart device comes within the coverage of a beacon signal, the smart device receives the corresponding signal and transfers the signal to a server connected thereto, with the result that the smart device is provided with a suitable service.

Here, RSSI indicates received signal strength, and is an index for measuring the distance between the beacon and the user. That is, through the RSSI, the distance between the beacon and the smart device can be measured, and the location of the smart device may be estimated using the beacon, as in the case of location estimation using trilateration in GPS. By utilizing RSSI, beacon-based indoor navigation is enabled and is utilized in various services.

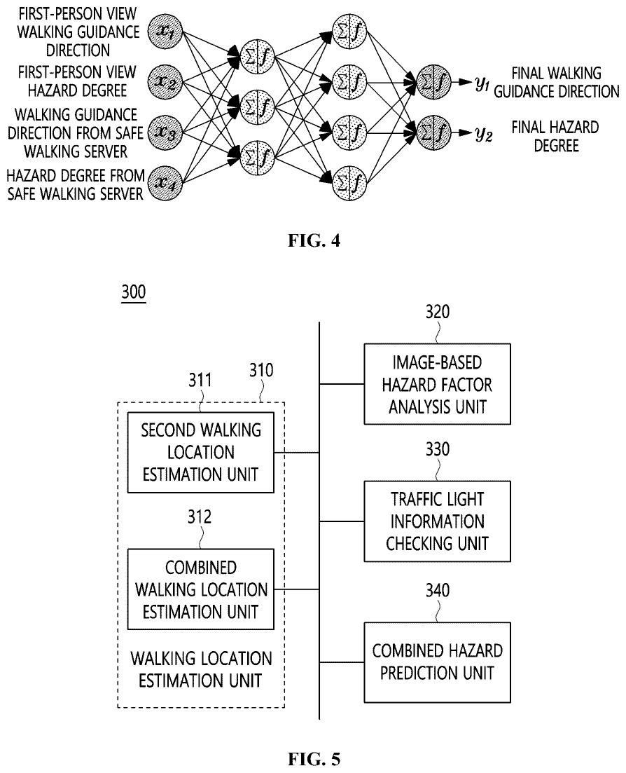

The safe walking server 300 may estimate a walking location based on the beacon signal and first-person view sensor information, may analyze hazard factors (danger factors) based on images, and may perform prediction of hazards around a pedestrian in which the walking location, the hazard factors, and the status information of the traffic light are considered together. The detailed configuration of the safe walking server 300 will be described later with reference to FIGS. 3 and 4.

FIG. 2 is a schematic block configuration diagram of a pedestrian guidance terminal according to an embodiment, FIG. 3 is a diagram illustrating the input/output of a combined safety determination unit according to an embodiment, and FIG. 4 is a diagram illustrating an example of a deep neural network for combined safety determination according to an embodiment.

Referring to FIG. 2, the pedestrian guidance terminal 100 may include a sensor unit 110, a Bluetooth module 120, a communication unit 130, an output unit 140, and a control unit 150.

The sensor unit 110 may be a navigation sensor within a user's proximity, and may include a camera, Light Detection and Ranging (LiDAR), an ultrasonic sensor, etc.

The Bluetooth module 120 may receive a beacon signal from a smart device 200-1 installed on a traffic light.

The communication unit 130 may transmit the received beacon signal and first walking location information to the safe walking server 300 in a wireless manner, or may receive secondary walking information from the safe walking server 300 in a wireless manner.

The output unit 140 may be a means capable of visually, audibly, or tactilely outputting walking guidance information and hazard warning.

The control unit 150 may perform walking guidance so as to allow a pedestrian to safely walk at a crosswalk as he or she arrives around a traffic light after starting walking along a path.

In accordance with an embodiment, the control unit 150 may include a primary walking information generation unit 151 and a combined safety determination unit 152.

The primary walking information generation unit 151 may generate primary walking information by determining the first walking location and the hazardous situation of the pedestrian at the crosswalk based on first-person view sensor information output from the sensor unit 110. For example, when sensor information such as a first-person view image, is input, the primary walking information generation unit 151 informs the pedestrian of the direction of walking guidance and a hazardous (dangerous) situation based on the results of estimating the location of the pedestrian at the crosswalk and detecting an obstacle.

Here, the primary walking information generation unit 151 may output in advance the primary walking information before receiving secondary walking information.

The combined safety determination unit 152 may output final walking information by determining safety in combination based on the primary walking information and the secondary walking information received from the safe walking server 300.

That is, referring to FIG. 3, the combined safety determination unit 152 may output the final walking guidance information and hazard warning by determining safety in combination based on the walking guidance information and the result of predicting hazards around the pedestrian, which are estimated based on the first-person view sensor information, and the walking guidance information and the result of predicting hazards around the pedestrian, which are received from the safe walking server.

Here, each of the primary walking information, the secondary walking information, and the final walking information may include a walking guidance direction and a hazard degree. In this way, in order to receive the secondary walking information from the safe walking server 300, as a beacon signal is received through the Bluetooth module 120 after the pedestrian starts walking along the path, the combined safety determination unit 152 may control the communication unit 130 to transmit the beacon signal to the safe walking server 300 through the communication unit 130.

Also, the combined safety determination unit 152 may transfer a first walking location estimated by the primary walking information generation unit 151 to the safe walking server 300.

When the combined safety determination unit 152 according to the embodiment is utilized, the essential problems of the conventional first-person view-based walking guidance system, that is, occlusion of the first-person view sensor and the deterioration of result reliability attributable to environmental factors or the like, may be solved, and thus qualitative improvement of reliability may be realized. That is, walking guidance is determined by integrating first-person view information (e.g., images, sensor, etc.), obtained when the pedestrian looks at himself or herself, with the result of analyzing CCTV footage (video or images) corresponding to a third-person view and real-time signal information, thus enabling integrated and highly reliable walking guidance and hazard determination to be performed.

In accordance with an embodiment, as illustrated in FIG. 4, the combined safety determination unit 152 may determine safety in combination based on a pre-trained Deep Neural Network (DNN) which infers a final walking guidance direction and a final hazard degree by receiving a primary walking guidance direction, a primary hazard degree, a secondary walking guidance direction, and a secondary hazard degree as input.

For this, the deep neural network such as that illustrated in FIG. 4 may be pre-trained with a training data pair composed of input data that includes the primary walking guidance direction, the primary hazard degree, the secondary walking guidance direction, and the secondary hazard degree and output data that includes the final walking guidance direction and the final hazard degree.

Here, as the deep neural network, a Convolutional Neural Network (CNN), ResNet, a Transformer, etc. may be utilized.

In accordance with another embodiment, the combined safety determination unit 152 may perform hybrid safety determination. That is, this scheme is configured to stochastically represent hazards and safe walking factors and perform walking guidance and hazard warning with higher probability.

In accordance with a further embodiment, the combined safety determination unit 152 may perform selective safety determination. That is, multiple situations may be represented for respective cases, and walking guidance and hazard warning may be suitably performed depending on the cases.

The combined safety determination unit 152 may help a vulnerable pedestrian safely walk based on the inferred final walking guidance direction and the final hazard degree. That is, the combined safety determination unit 152 may output walking guidance and hazard warning to be transferred to the user (vulnerable pedestrian).

As described above, in an embodiment, the combined safety determination unit 152 may be added on to and utilized with the primary walking information generation unit 151.

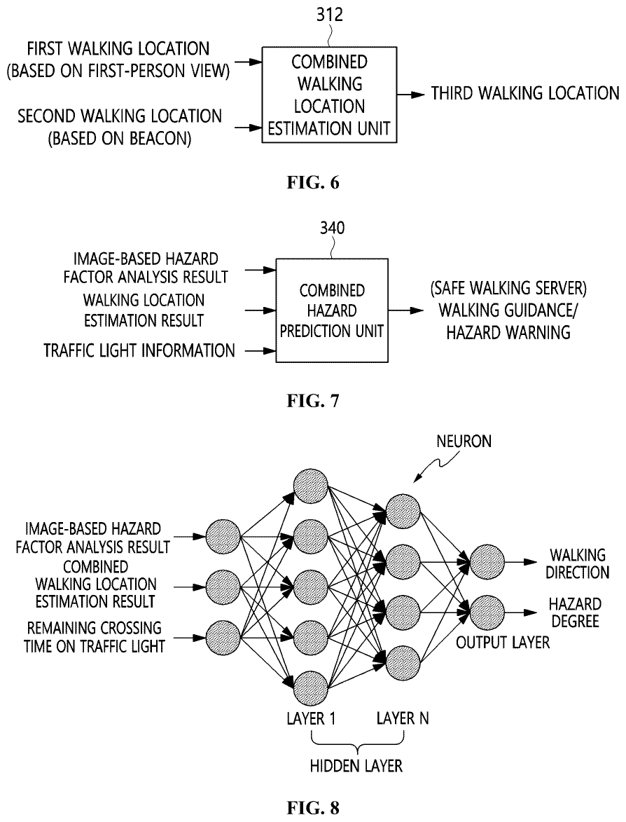

FIG. 5 is a schematic block configuration diagram of a safe walking server according to an embodiment, FIG. 6 is a diagram illustrating the input/output of a combined walking location estimation unit according to an embodiment, FIG. 7 is a diagram illustrating the input/output of a combined hazard estimation unit according to an embodiment, and FIG. 8 is a diagram illustrating an example of a deep neural network for combined hazard prediction according to an embodiment.

Referring to FIG. 5, the safe walking server 300 according to an embodiment may include a walking location estimation unit 310, an image-based hazard factor analysis unit 320, a traffic light information checking unit 330, and a combined hazard prediction unit 340.

The walking location estimation unit 310 may estimate a walking location based on a beacon signal, corresponding to at least one traffic light, and first-person view sensor information.

Also, the walking location estimation unit 310 may add an image (video) acquired from a camera around the traffic light to the beacon signal and the first-person view sensor information, thus estimating the walking location in combination.

That is, the walking location estimation unit 310 may receive a first walking location estimated based on the first-person view sensor information received from a pedestrian guidance terminal, may estimate a second walking location based on the beacon signal, and may estimate a third walking location by combining the first walking location and the second walking location.

For this operation, the walking location estimation unit 310 may include a second walking location estimation unit 311 which estimates the second walking location based on the beacon signal, and a combined walking location estimation unit 312 which estimates the third walking location by combining the second walking location and the first walking location received from the pedestrian guidance terminal 100.

The reason for this is to solve a problem in which the case where estimation of a walking location is difficult frequently occurs due to signal interference or the like because Bluetooth beacon technology fundamentally has limited coverage and is shortwave radio technology.

That is, the combined walking location estimation unit 312 according to an embodiment may combine a first walking location estimation technique for estimating a walking location from a first-person view by the pedestrian guidance terminal 100 with a beacon-based walking location estimation technique by the second walking location estimation unit 311, thereby overcoming the disadvantages of respective techniques and maximizing the advantages thereof.

Here, the second walking location estimation unit 311 may determine whether the pedestrian guidance terminal 100 has received beacon signals from four or more traffic lights including the identified traffic light when estimating the second walking location. That is, whether beacon signals received from the four or more traffic lights are transferred to the pedestrian guidance terminal 100 may be determined.

When it is determined that beacon signals have been received from the four or more traffic lights, the walking location may be estimated through trilateration using four or more beacon signals.

Furthermore, as illustrated in FIG. 6, the combined walking location estimation unit 312 may estimate a point having a highest value based on at least one of the probabilities or reliabilities of respective results of estimating the first walking location and the second walking location or a combination thereof to be a third walking location when estimating the third walking location.

That is, the combined walking location estimation unit 312 may select the result of estimating the second walking location when the probability of first walking location estimation is low. On the other hand, when the combined walking location estimation unit 312 may select the result of estimating the first walking location when the probability of second walking location estimation is low due to signal interference.

In accordance with an embodiment, the combined walking location estimation unit 312 may perform hybrid location estimation. That is, respective results of estimating the first walking location and the second walking location may be stochastically represented, and a point having the highest probability in an integrated manner may be estimated to be the third walking location.

In accordance with another embodiment, the combined walking location estimation unit 312 may perform selective location estimation depending on the situation. That is, the reliabilities of respective results of estimating the first walking location and the second walking location may be analyzed, and a result having high reliability may be selectively used.

In accordance with a further embodiment, the combined walking location estimation unit 312 may perform highly-reliable location estimation by utilizing a location estimation algorithm for multi-modal sensor-based navigation.

The image-based hazard factor analysis unit 320 may analyze hazard factors around the pedestrian based on images acquired from the camera corresponding to each traffic light.

Here, the image-based hazard factor analysis unit 320 may search for at least one camera around the identified traffic light, receive real-time images (video) around the crosswalk from the found at least one camera, and recognize hazard factors including respective speeds of one or more vehicles (e.g., a car, a motorcycle, a bicycle, etc.) approaching the crosswalk, lanes, obstacles, and the degree of walking congestion when analyzing hazard factors around the pedestrian.

For example, when real-time footage from a CCTV installed at a high place where the entire crosswalk is captured is utilized, the input of a first-person view sensor may be prevented from being occluded.

Here, in accordance with an embodiment, the image-based hazard factor analysis unit 320 may perform lane detection and vehicle-wise speed estimation through vehicle detection and tracking for respective frames in real-time footage. That is, hazard information may be delivered to the pedestrian by inferring real-time speeds of the corresponding vehicle in respective lanes.

In accordance with another embodiment, the image-based hazard factor analysis unit 320 may deliver hazard information to the pedestrian by detecting and tracking a motorcycle, a bicycle, and each pedestrian.

The result of estimation of the walking location, which is the last input, may be obtained by utilizing the result of combined walking location estimation in which the result of location estimation by the first-person view-based walking guidance system and the result of beacon-based location estimation are combined with each other.

The traffic signal information checking unit 330 may receive traffic light information (or traffic light status information) including the color and lighting time of the traffic light from the smart traffic light 200-1.

Here, the traffic light information may include information about the color and the remaining time for the pedestrian to cross (i.e., remaining crossing time). Because such traffic light information is directly related to the hazardous situation of the pedestrian and then the reliability thereof is of utmost importance, it may be desirable to directly receive in real time the traffic light information from the smart traffic light 200-1 and utilize the received traffic light information. In particular, because it is difficult to predict the time remaining until the color of the pedestrian traffic light changes (i.e., the remaining crossing time) or the like, it may be very important to directly receive the traffic light information from the smart traffic light 200-1.

Then, as shown in FIG. 7, the combined hazard prediction unit 340 may predict hazards around the pedestrian in combination by considering together the walking location, the hazard factors, and the traffic light status information.

Thereafter, walking guidance based on the predicted hazards around the pedestrian may be provided to the pedestrian guidance terminal 100.

Here, according to an embodiment, as illustrated in FIG. 8, the combined hazard prediction unit 340 may perform hazard prediction based on a Deep Neural Network (DNN) pre-trained to infer a walking direction and a hazard degree by receiving the walking location, the result of analysis of hazard factors around the pedestrian, and the traffic light status information as input when predicting hazards in combination.

For this, the deep neural network such as that illustrated in FIG. 8 may be pre-trained with a training data pair composed of input data that includes the primary walking guidance direction, the primary hazard degree, the secondary walking guidance direction, and the secondary hazard degree and output data that includes the final walking guidance direction and the final hazard degree.

Here, as the deep neural network, a Convolutional Neural Network (CNN), ResNet, a Transformer, etc. may be utilized

In accordance with another embodiment, the combined hazard prediction unit 340 may perform hazard detection based on heuristic hazard prediction for calculating a hazard degree in each hazardous situation based on the hazard degrees manually set for hazardous situations designated for respective cases.

That is, hazardous situations may be designated for respective cases, and the hazard degrees may be manually configured. When the configured hazardous situation occurs, the hazard degree corresponding to the hazardous situation may be derived. For example, in the case where the pedestrian passes through a first lane of the road, when the speed of a vehicle in the first lane is equal to or greater than a threshold value, the hazard degree may be designated as “high”. Alternatively, the remaining crossing time and the walking speed of the pedestrian are analyzed. When the walking of the pedestrian is too slow, the hazard degree may be designated as “high”, and the pedestrian may be induced to stop walking and to turn back.

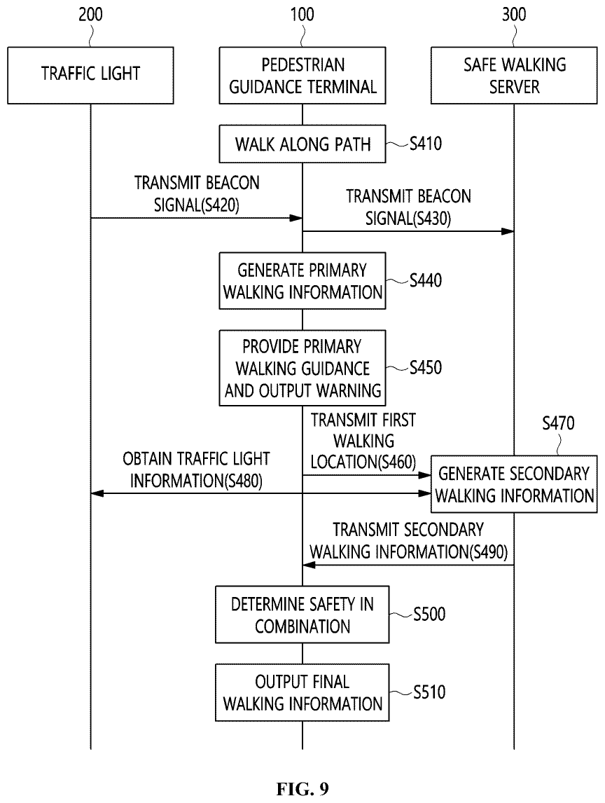

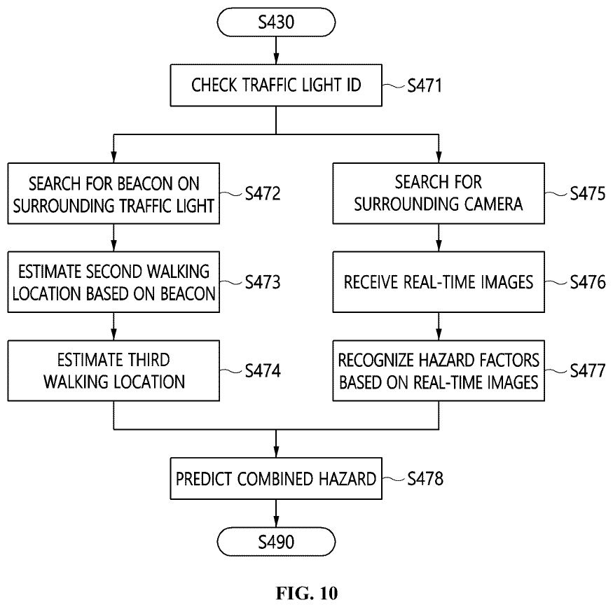

FIG. 9 is a signal flowchart for explaining a method for providing crosswalk pedestrian guidance based on an image and a beacon according to an embodiment, and FIG. 10 is a flowchart for explaining the detailed step of generating secondary walking information according to an embodiment.

Referring to FIG. 9, in the method for providing crosswalk pedestrian guidance based on an image and a beacon according to the embodiment, as the pedestrian guidance terminal 100 receives a beacon signal through a Bluetooth module at step S420 after a pedestrian starts walking along a path at step S410, the pedestrian guidance terminal 100 transfers the received beacon signal to the safe walking server 300 at step 430. Thereafter, the pedestrian guidance terminal 100 generates primary walking information by determining the first walking location and a hazardous situation of the pedestrian at a crosswalk based on sensing data output from the sensor unit 110 at step S440.

Thereafter, the pedestrian guidance terminal 100 may first output the primary walking information at step S450. Here, the primary walking information may include a walking guidance direction and a hazard degree.

Further, the pedestrian guidance terminal 100 may transfer the first walking location to the safe walking server 300 at step S460.

Meanwhile, in the method for providing crosswalk pedestrian guidance based on an image and a beacon according to the embodiment, as the beacon signal is received from the pedestrian guidance terminal 100 at step S430, the safe walking server 300 generates secondary walking information at step S470.

In detail, referring to FIG. 10, the safe walking server 300 identifies a traffic light that has transmitted the beacon signal at step S471.

Thereafter, the safe walking server 300 estimates a walking location based on the result of detecting whether the pedestrian guidance terminal has received beacon signals transmitted from other traffic lights around the identified traffic light at steps S472 and S473.

Here, the safe walking server 300 checks whether the pedestrian guidance terminal 100 has received beacon signals from four or more traffic lights including the identified traffic light at step 472.

When the pedestrian guidance terminal 100 has received the beacon signals from four or more traffic lights, the safe walking server 300 estimates a second walking location through trilateration using the four or more beacon signals at step S473.

Thereafter, the safe walking server 300 estimates a third walking location by combining the first walking location received from the pedestrian guidance terminal with the second walking location at step S474.

Here, based on at least one of the probabilities or reliabilities of respective results of estimating the first walking location and the second walking location or a combination thereof, a point having a highest value may be estimated to be the third walking location.

Furthermore, the safe walking server 300 may analyze hazard factors around the pedestrian based on real-time images (video or footage) acquired from a camera around the identified traffic light at steps S475 to S477.

Here, the safe walking server 300 searches for at least one camera 200-1 around the identified traffic light at step S475, receives real-time images captured from the area around the crosswalk from the found at least one camera 200-1 at step S476, and recognizes hazard factors including respective speeds of one or more vehicles approaching the crosswalk, lanes, obstacles, and the degree of walking congestion at step S477.

Thereafter, the safe walking server 300 predicts hazards around the pedestrian in combination based on the estimated walking location and the result of analysis of the hazard factors around the pedestrian at step S478.

Meanwhile, referring back to FIG. 9, the safe walking server 300 may receive traffic light information including the color and lighting time of the traffic light from the smart traffic light at step S480.

Therefore, at step S478 of predicting the hazards in the combined manner in FIG. 10, the traffic light information received from the smart traffic light may be further included in the hazard prediction result, and thus hazards may be predicted.

Here, in accordance with an embodiment, the safe walking server 300 may perform hazard prediction based on a Deep Neural Network (DNN) pre-trained to infer a walking direction and a hazard degree by receiving the walking location, the result of analysis of hazard factors around the pedestrian, and the traffic light information as input when predicting hazards in the combined manner at step S478.

Here, in accordance with another embodiment, the safe walking server 300 may perform hazard detection based on heuristic hazard prediction for calculating a hazard degree in each hazardous situation based on the hazard degrees manually set for hazardous situations designated for respective cases when predicting hazards in the combined manner at step S478.

Referring back to FIG. 9, the safe walking server 300 transmits the secondary walking information to the pedestrian guidance terminal 100 based on the predicted hazards around the pedestrian at step S490.

Then, the pedestrian guidance terminal 100 may determine safety in combination based on the primary walking information and the secondary walking information received from the safe walking server 300 at step S500, and may then output final waking information at step S510.

Here, the pedestrian guidance terminal 100 may perform combined determination of safety based on a pre-trained deep neural network which infers the final walking guidance direction and the final hazard degree by receiving a primary walking guidance direction, a primary hazard degree, a secondary walking guidance direction, and a secondary hazard degree as input when determining safety in combination at step S500.

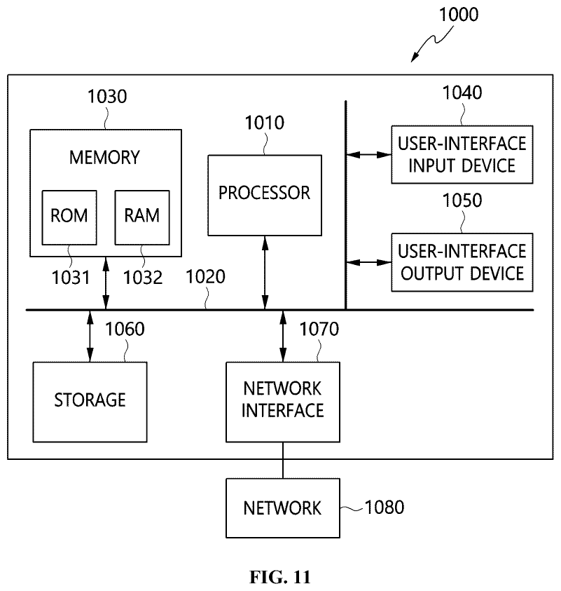

FIG. 11 is a diagram illustrating the configuration of a computer system according to an embodiment.

Each of a pedestrian guidance terminal 100 and a safe walking server 300 according to an embodiment may be implemented in a computer system 1000, such as a computer-readable storage medium.

The computer system 1000 may include one or more processors 1010, memory 1030, a user interface input device 1040, a user interface output device 1050, and storage 1060, which communicate with each other through a bus 1020. The computer system 1000 may further include a network interface 1070 connected to a network 1080. Each processor 1010 may be a Central Processing Unit (CPU) or a semiconductor device for executing programs or processing instructions stored in the memory 1030 or the storage 1060. Each of the memory 1030 and the storage 1060 may be a storage medium including at least one of a volatile medium, a nonvolatile medium, a removable medium, a non-removable medium, a communication medium or an information delivery medium, or a combination thereof. For example, the memory 1030 may include Read-Only Memory (ROM) 1031 or Random Access Memory (RAM) 1032.

According to an embodiment, walking guidance that may help a vulnerable pedestrian safely cross the road at a crosswalk with a traffic light can be provided.

According to an embodiment, occlusion occurring when a first-person view sensor used in walking guidance is hidden by an obstacle, or a problem occurring when the first-person view sensor faces in a direction other than that of the target to be recognized may be solved.

According to an embodiment, the color of a traffic light, the location of a crosswalk, and the existence of a moving object may be accurately detected so as to provide walking guidance, regardless of environmental variables such as illuminance, backlight, and weather.

Although the embodiments of the present disclosure have been disclosed with reference to the attached drawing, those skilled in the art will appreciate that the present disclosure can be implemented in other concrete forms, without changing the technical spirit or essential features of the disclosure. Therefore, it should be understood that the foregoing embodiments are merely exemplary, rather than restrictive, in all aspects.

What is claimed is:

1. A method for providing crosswalk pedestrian guidance based on an image and a beacon, comprising:
estimating a walking location based on a beacon signal corresponding to at least one traffic light and first-person view sensor information;
analyzing a hazard factor around a pedestrian based on an image acquired from a camera corresponding to the traffic light;
predicting a hazard around the pedestrian in combination by considering together the walking location, the hazard factor, and status information of the traffic light; and
providing walking guidance to a pedestrian guidance terminal based on the predicted hazard around the pedestrian.

2. The method of claim 1, wherein estimating the walking location comprises:
receiving a first walking location estimated based on the first-person view sensor information from the pedestrian guidance terminal;
estimating a second walking location based on the beacon signal; and
estimating a third walking location by combining the first walking location with the second walking location.

3. The method of claim 2, wherein estimating the second walking location comprises:
estimating the second walking location through trilateration based on beacon signals received by the pedestrian guidance terminal from four or more traffic lights.

4. The method of claim 2, wherein estimating the third walking location comprises:
estimating a point having a highest value to be the third walking location based on at least one of probabilities or reliabilities of respective results of estimating the first walking location and the second walking location, or a combination thereof.

5. The method of claim 1, wherein analyzing the hazard factor around the pedestrian comprises:
searching for at least one camera around an identified traffic light;
receiving a real-time image around a crosswalk from the found at least one camera; and
recognizing a hazard factor including a speed of at least one vehicle approaching the crosswalk, a lane, an obstacle, and a degree of walking congestion.

6. The method of claim 1, wherein the traffic light status information includes a color and a lighting time of the traffic light.

7. The method of claim 6, wherein predicting the hazard in the combined manner is performed based on a deep neural network that is pre-trained to infer a walking direction and a hazard degree by receiving the walking location, the hazard factor, and the traffic light status information as input.

8. The method of claim 6, wherein predicting the hazard in the combined manner is performed based on heuristic hazard prediction of calculating a hazard degree in a corresponding hazardous situation based on hazard degrees manually set for hazardous situations designated for respective cases.

9. An apparatus for providing crosswalk pedestrian guidance based on an image and a beacon, comprising:
a memory configured to store at least one program; and
a processor configured to execute the program,
wherein the program is configured to estimate a walking location based on a beacon signal corresponding to at least one traffic light and first-person view sensor information, analyze a hazard factor around a pedestrian based on an image acquired from a camera corresponding to the traffic light, predict a hazard around the pedestrian in combination by considering together the walking location, the hazard factor, and status information of the traffic light, and provide walking guidance to a pedestrian guidance terminal based on the predicted hazard around the pedestrian.

10. The apparatus of claim 9, wherein the program is configured to, in estimating the walking location, receive a first walking location estimated based on the first-person view sensor information from the pedestrian guidance terminal, estimate a second walking location based on the beacon signal, and estimate a third walking location by combining the first walking location with the second walking location.

11. The apparatus of claim 10, wherein the program is configured to, in estimating the second walking location, estimate the second walking location through trilateration based on beacon signals received by the pedestrian guidance terminal from four or more traffic lights including an identified traffic light.

12. The apparatus of claim 10, wherein the program is configured to, in estimating the third walking location, estimate a point having a highest value to be the third walking location based on at least one of probabilities or reliabilities of respective results of estimating the first walking location and the second walking location, or a combination thereof.

13. The apparatus of claim 9, wherein the program is configured to, in analyzing the hazard factor around the pedestrian, search for at least one camera around an identified traffic light, receive a real-time image around a crosswalk from the found at least one camera, and recognize a hazard factor including a speed of at least one vehicle approaching the crosswalk, a lane, an obstacle, and a degree of walking congestion.

14. The apparatus of claim 9, wherein the traffic light status information includes a color and a lighting time of the traffic light.

15. The apparatus of claim 14, wherein the program is configured to, in predicting the hazard in the combined manner, perform hazard prediction based on a deep neural network that is pre-trained to infer a walking direction and a hazard degree by receiving the walking location, the hazard factor, and the traffic light status information as input.

16. A pedestrian guidance terminal, comprising:
a memory configured to store at least one program; and
a processor configured to execute the program,
wherein the program is configured to output final walking guidance information and hazard warning by determining safety in combination based on walking guidance information and a result of predicting a hazard around a pedestrian, which are estimated based on first-person view sensor information, and walking guidance information and a result of predicting a hazard around the pedestrian, which are received from a safe walking server.

17. The pedestrian guidance terminal of claim 16, wherein the program is configured to transfer a beacon signal received from a smart device installed on a traffic light to the safe walking server after the pedestrian starts walking along a path.

18. The pedestrian guidance terminal of claim 16, wherein the program is configured to transfer a first waling location estimated based on the first-person view sensor information to the safe walking server.

19. The pedestrian guidance terminal of claim 16, wherein the program is configured to output in advance primary walking information based on the walking guidance information and the result of predicting the hazard around the pedestrian, which are estimated based on the first-person view sensor information, before receiving the walking guidance information and the result of predicting the hazard around the pedestrian from the safe walking server.

20. The pedestrian guidance terminal of claim 16, wherein the program is configured to output final walking information based on a pre-trained deep neural network that infers a final walking guidance direction and a final hazard degree by receiving a primary walking guidance direction, a primary hazard degree, a secondary walking guidance direction, and a secondary hazard degree as input.
